(19) United States
(12) Patent Application Publication
(10) Pub. No.: US 2008/0295494 A1
(43) Pub. Date: Dec. 4, 2008

(54) Multi-engine system with on-board ammonia production

(76) Inventors: James Joshua Driscoll, Dunlap, IL (US); Weidong Gong, Dunlap, IL (US); Wade Robel, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/806,384

(22) Filed: May 31, 2007

(51) Int. Cl. F01N 3/035; B60K 13/04

(52) U.S. Cl. 60/286; 180/309; 60/274; 60/279

(57) ABSTRACT

A power system is provided having a first power source including at least one engine configured to combust a first air/fuel mixture and produce a first exhaust stream. The system also has a first exhaust passageway fluidly connected to the first power source and configured to receive the first exhaust stream. In addition, the system has a second power source including at least one engine configured to combust a second fuel/air mixture and produce a second exhaust stream. Furthermore, the system has a second exhaust passageway fluidly connected to the second power source and configured to receive the second exhaust stream. The system further has a first catalyst disposed within the first exhaust passageway to convert at least a portion of the first exhaust stream to ammonia

### TECHNICAL FIELD

The present disclosure is directed to a multi-engine system and more particularly, to a multi-engine system with at least one engine having an on-board ammonia producing capability.

### BACKGROUND

Fossil fuel powered systems for engines, factories, and power plants typically produce emissions that contain a variety of pollutants. These pollutants may include, for example, particulate matter, nitrogen oxides (NOx), and sulfur compounds. Due to heightened environmental concerns, exhaust emission standards have become increasingly stringent. The amount of pollutants in the exhaust stream may be regulated depending on the type, size, and/or class of engine.

One method used to reduce emissions is selective catalytic reduction (SCR). SCR provides a method for removing NOx emissions from internal combustion engine systems. During SCR, a catalyst facilitates a reaction between exhaust-gas ammonia and NOx to produce water vapor and nitrogen gas, thereby removing NOx from the exhaust gas. The ammonia that is used for the SCR system may be stored for injection when needed. However, because of the high reactivity of ammonia, storage of ammonia can be hazardous. In addition, machines utilizing SCR systems sometimes operate in remote locations where it may be difficult to replenish any ammonia storage system. On-board ammonia production may provide a safer and more practical alternative to ammonia storage.

U.S. Pat. No. 5,964,088 (the '088 patent) issued to Kinugasa et al. on Oct. 12, 1999, discloses two embodiments of a system utilizing on-board ammonia production. One embodiment disclosed in the '088 patent includes a multi-cylinder engine that combusts a lean air/fuel mixture. A first cylinder of the engine is fluidly connected to an exhaust passageway that has an ammonia synthesizing catalyst, while the other cylinders are fluidly connected to an SCR catalytic device. A separate auxiliary engine combusts a rich air/fuel mixture and is fluidly connected to the exhaust passageway with the ammonia synthesizing catalyst. Rich exhaust gas from the auxiliary engine is mixed with lean exhaust gas from the first cylinder, and NOx contained in the mixture reacts with the ammonia synthesizing catalyst to generate ammonia. The ammonia is then directed to the SCR catalytic device where it reacts with the lean exhaust of the remaining cylinders to reduce NOx.

In the second embodiment, all of the engine cylinders combust a lean air/fuel mixture and are fluidly connected to an SCR catalytic device. The separate auxiliary engine is replaced with a burner that burns a rich air/fuel mixture and is fluidly connected to an ammonia synthesizing catalyst. NOx in the rich exhaust gas produced by the burner reacts with the ammonia synthesizing catalyst, and the resulting ammonia is directed to the SCR catalytic device. There, the ammonia is mixed with the lean exhaust produced by the engine cylinders and reacts with the SCR catalytic device to remove NOx from the engine emissions.

Although the system in the '088 patent may reduce NOx emissions, the utilization of lean exhaust gas or a burner to generate ammonia may limit the NOx reducing capability of the system. In particular, the lean exhaust gas contains a large amount of oxygen which adversely affects the production of ammonia. In addition, the burner combusts the rich air/fuel mixture at a temperature that is unfavorable for NOx production, thereby limiting ammonia generation. NOx reduction in both embodiments is limited because only a limited amount of ammonia is available to react with the SCR catalytic device.

In addition, the engine system disclosed in the '088 patent consumes a larger amount of fuel to produce a particular mechanical or electrical output than a conventional power system without on-board ammonia production. This is because additional fuel is needed to power the auxiliary engine and the burner, which do not contribute to the production of the mechanical or electrical output. Therefore, energy from the additional fuel is used solely to produce ammonia and is not used to accomplish the task being performed by the main engine. By using the additional fuel, operational costs may increase and the system efficiency may decrease.

The disclosed system is directed to overcoming one or more of the problems set forth above.

### SUMMARY OF THE INVENTION

In one aspect, the present disclosure is directed toward a power system that includes a first power source including at least one engine configured to combust a first air/fuel mixture and produce a first exhaust stream. The system also includes a first exhaust passageway fluidly connected to the first power source and configured to receive the first exhaust stream. In addition, the system includes a second power source having at least one engine configured to combust a second air/fuel mixture and produce a second exhaust stream. Furthermore, the system includes a second exhaust passageway fluidly connected to the second power source and configured to receive the second exhaust stream. The system further includes a first catalyst disposed within the first exhaust passageway to convert at least a portion of the first exhaust stream to ammonia.

Consistent with another aspect of the disclosure, a method is provided for operating a power system. The method includes simultaneously combusting a first and second air/fuel mixture to produce multiple mechanical outputs. In addition, the method includes producing a first and second exhaust stream from the combustion of the first and second air/fuel mixtures. Furthermore, the method includes converting at least a portion of the first exhaust stream to ammonia.

### BRIEF DESCRIPTION OF THE DRAWINGS

FIG. 1 is a diagrammatic illustration of an exemplary disclosed machine;

FIG. 2 is a diagrammatic illustration of an exemplary disclosed power system for use with the machine of FIG. 1;

FIG. 3 is a schematic illustration of another exemplary embodiment of the disclosed power system; and

FIG. 4 is a flow chart depicting an exemplary method for operating the power system.

### DETAILED DESCRIPTION

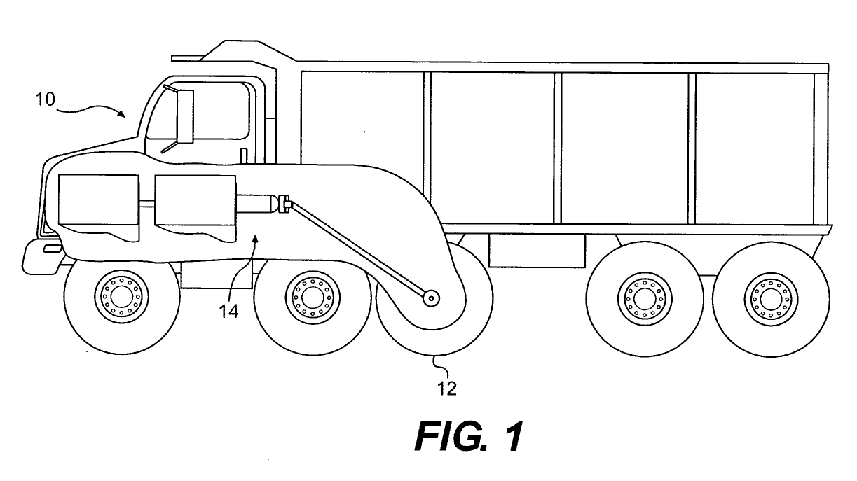

FIG. 1 illustrates an exemplary machine 10 having multiple systems and components that cooperate to accomplish a task. The tasks performed by machine 10 may be associated with a particular industry such as mining, construction, farming, transportation, power generation, or any other industry known in the art. For example, machine 10 may embody a mobile machine such as the vehicle depicted in FIG. 1, a bus, a haul truck, or any other type of machine known in the art. Machine 10 may include one or more traction devices 12 operatively connected to and driven by a power train 14.

Traction devices 12 may embody wheels located on each side of machine 10 (only one side shown). Alternatively, traction devices 12 may include tracks, belts or other known traction devices. It is contemplated that any combination of the wheels on machine 10 may be driven and/or steered.

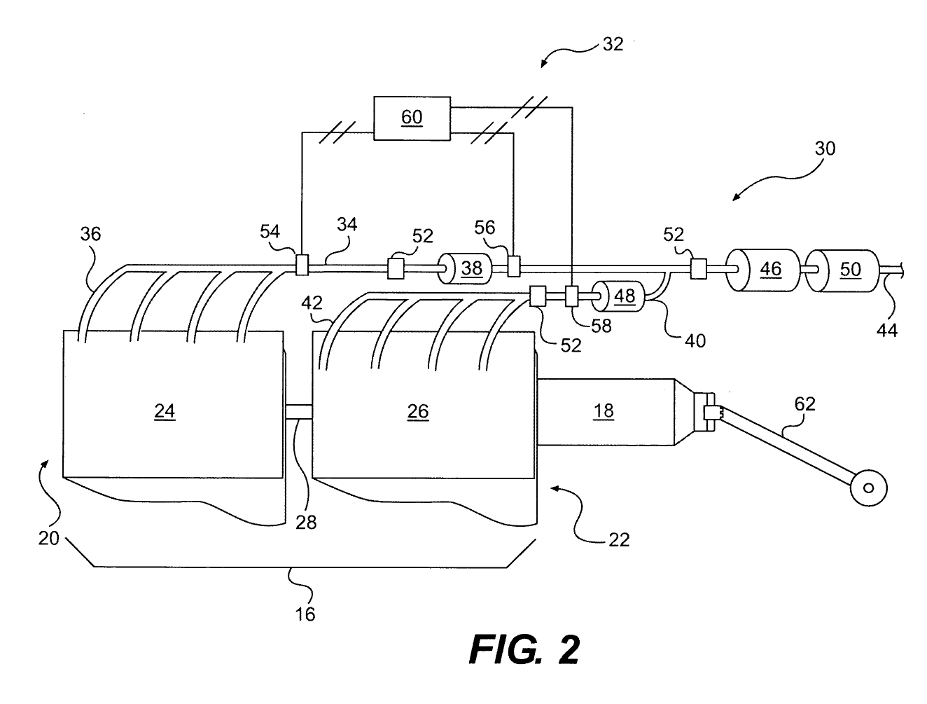

Power train 14 may be an integral package configured to generate and transmit power to traction devices 12. In particular, as shown in FIG. 2, power train 14 may include a power system 16 operable to generate a power output and a transmission unit 18 connected to receive the power output and transmit the power output in a useful manner to traction devices 12.

Power system 16 may include a first power source 20 configured to combust a rich air/fuel mixture and a second power source 22 configured to combust a lean air/fuel mixture. First power source 20 may include at least one rich engine 24, while second power source 22 may include at least one lean engine 26. For the purposes of this disclosure, rich engine 24 and lean engine 26 are depicted and described as natural gas powered engines. However, one skilled in the art will recognize that rich engine 24 and lean engine 26 may be any other type of internal combustion engine such as, for example, a gasoline, a diesel, or a gaseous fuel-powered engine. First power source 20 may be operationally connected to second power source 22 by, for example, a countershaft 28, a belt (not shown), an electrical circuit (not shown), or in any other suitable manner such that first power source 20 and second power source 22 cooperatively contribute to produce a mechanical or electrical output. It is contemplated that in configurations utilizing multiple rich engines 24 and/or multiple lean engines 26, each rich engine 24 may be operationally connected to other rich engines 24 and lean engines 26 may be operationally connected to other lean engines 26 by, for example, countershaft 28, a belt (not shown), an electrical circuit (not shown), or in any other suitable manner such that all rich engines 24 and lean engines 26 cooperatively contribute to produce a mechanical or electrical output. It is further contemplated that although first power source 20 and second power source 22 are disclosed as being situated in series, first and second power sources 20 and 22 may be disposed in a parallel configuration, if desired. It is yet further contemplated that rich engine 24 may embody an auxiliary power unit, if desired.

Power system 16 may have multiple subsystems that cooperate to produce a mechanical or electrical power output. Among such subsystems included within power system 16 may be an exhaust system 30 and a control system 32.

Exhaust system 30 may remove or reduce the amount of pollutants in the exhaust produced by power system 16 and release the treated exhaust into the atmosphere. Exhaust system 30 may include an exhaust passageway 34 fluidly connected to an exhaust manifold 36 of first power source 20, an ammonia-producing catalyst 38 disposed within exhaust passageway 34, an exhaust passageway 40 fluidly connected to an exhaust manifold 42 of second power source 22, a merged exhaust passageway 44 fluidly connected to exhaust passageways 34 and 40, and a selective catalytic reduction (SCR) catalyst 46 disposed within merged exhaust passageway 44. It is contemplated that exhaust system 30 may further include additional after-treatment devices, such as, for example, one or more oxidation catalysts 48, an ammonia oxidation catalyst 50, one or more particulate filters 52, and/or any other after-treatment device known in the art that is capable of removing or reducing unwanted emissions from the exhaust, if desired.

Ammonia-producing catalyst 38 may generate ammonia by facilitating a reaction between NOx and other combustion byproducts in the exhaust-gas stream of first power source 20. These other combustion byproducts may include, for example, hydrogen gas (H₂), propene (C₃H₆), or carbon monoxide (CO). In addition, ammonia-producing catalyst 38 may include a variety of materials, such as, for example, platinum, palladium, rhodium, iridium, copper, chrome, vanadium, titanium, iron, cesium, or any other material capable of generating ammonia. Combinations of these materials may be used, and the catalyst material may be chosen based on the type of fuel used, the air/fuel ratio desired, or for conformity with environmental standards.

The efficiency of the ammonia-producing reaction may be improved under rich conditions. Therefore, the air/fuel mixture combusted within first power source 20 may be made rich to generate a rich exhaust favorable for increased ammonia production. Alternatively, a fuel-supply device (not shown) may be fluidly connected to exhaust passageway 34 upstream of ammonia-producing catalyst 38 and configured to supply fuel into exhaust passageway 34. The injection of fuel into the exhaust of first power source 20 may produce favorable conditions for generating ammonia.

SCR catalyst 46 may facilitate a reaction between the ammonia generated by ammonia-producing catalyst 38 and NOx to at least partially remove NOx from the exhaust stream in merged exhaust passageway 44. For example, SCR catalyst 46 may facilitate a reaction between the ammonia and NOx to produce nitrogen gas and water, among other reaction products.

Oxidation catalyst 48 may be situated within exhaust passageway 40 and may regulate the levels of different NOx components in the exhaust of second power source 22 to increase the performance of SCR catalyst 46. It is contemplated that a plurality of oxidation catalysts 48 may alternatively be situated within each exhaust manifold 40 of second power source 22, if desired. NOx may include several oxides of nitrogen including nitrogen oxide (NO) and nitrogen dioxide (NO₂). However, SCR catalyst 46 may function most effectively with a NO:NO₂ ratio of 1:1. Therefore, oxidation catalyst 48 may be used to oxidize NO into NO₂ to regulate the ratio of NO to NO₂ in the exhaust stream of second power source 22 and increase the performance of SCR catalyst 46.

Ammonia oxidation catalyst 50 may be situated within merged exhaust passage 44 downstream of SCR catalyst 46 and may oxidize or burn any excess ammonia that may pass through SCR catalyst 46. During the exhaust treatment process, ammonia may be generated and supplied to SCR catalyst 46 at a rate that may exceed the NOx reducing capacity of SCR catalyst 46. The excess ammonia, known as ammonia slip, may be expelled from SCR catalyst 46 and may contribute to undesired emissions released into the atmosphere. In addition, the excess ammonia may corrode the surfaces of exhaust treatment equipment located downstream of SCR catalyst 46, which can lead to maintenance issues. Ammonia oxidation catalyst 50 may prevent such issues by converting the excess ammonia to nitrogen gas (N₂).

Particulate filter 52 may be situated within exhaust passageway 34, exhaust passageway 40, and/or merged exhaust passageway 44 to remove particulate matter from the exhaust flow. It is contemplated that particulate filter 52 may include a catalyst for reducing an ignition temperature of the particulate matter trapped by recirculation particulate filter 52, a means for regenerating the particulate matter trapped by recirculation particulate filter 52, or both a catalyst and a means for regenerating. The means for regenerating may include, among other things, a fuel-powered burner, an electrically-resistive heater, an engine control strategy, or any other means for regenerating known in the art.

Control system 32 may regulate the air/fuel ratio of an air/fuel mixture combusted by first and second power sources 20 and 22 based on sensed NOx and ammonia levels in exhaust treatment system 30. By regulating the air/fuel ratio, first and second power sources 20 and 22 may generate an optimal amount of NOx and ammonia for exhaust treatment. Control system 32 may include a NOx sensor 54 situated within exhaust passageway 34 upstream of ammonia catalyst 38 and/or an ammonia sensor 56 situated within exhaust passageway 34 downstream of ammonia catalyst 38. Control system 32 may also include a NOx sensor 58 situated within exhaust passageway 38 and a controller 60. It should be understood that although FIG. 2 discloses that control system 32 includes three sensors, any number of sensors and any combination of sensors may be used. Furthermore, the sensors may be located anywhere within power system 10 that may adequately sense the amount of NOx and ammonia in exhaust system 30. For example, it is contemplated that control system 32 may include additional NOx sensors situated within exhaust passageway 44 either upstream or downstream of SCR catalyst 46, if desired

NOx sensor 54 may sense the amount of NOx generated by first power source 20 and may be mounted on exhaust passageway 34 upstream of ammonia catalyst 38. In addition, NOx sensor 54 may be configured to detect the level of NOx in the exhaust flow passing through exhaust passageway 34. At least a portion of NOx sensor 54 may extend through the wall of exhaust passageway 34 into the exhaust flow. In order to withstand the high temperatures in exhaust passageway 34, NOx sensor 54 may be constructed, for example, out of ceramic type metal oxides or any other suitable material. NOx sensor 54 may sample the exhaust for NOx, and convert that sensed value into a signal indicative of the NOx level therein.

Ammonia sensor 56 may sense the amount of ammonia generated by ammonia-producing catalyst 38 and may be mounted on exhaust passageway 34 downstream of ammonia-producing catalyst 38. In addition, ammonia sensor 56 may be configured to detect the level of ammonia in the exhaust flow passing through exhaust passageway 34. At least a portion of ammonia sensor 56 may extend through the wall of exhaust passageway 34 into the exhaust flow. In order to withstand the high temperatures in exhaust passageway 34, ammonia sensor 56 may be constructed, for example, out of ceramic type metal oxides or any other suitable material. Ammonia sensor 56 may sample the exhaust for ammonia, and convert that sensed value into a signal indicative of the ammonia level therein.

NOx sensor 58 may sense the amount of NOx generated by second power source 22 and may be mounted on exhaust passageway 40. In addition, NOx sensor 58 may be configured to detect the level of NOx in the exhaust flow passing through exhaust passageway 40. At least a portion of NOx sensor 58 may extend through the wall of exhaust passageway 40 into the exhaust flow. In order to withstand the high temperatures in exhaust passageway 40, NOx sensor 58 may be constructed, for example, out of ceramic type metal oxides or any other suitable material. NOx sensor 58 may sample the exhaust for NOx, and convert that sensed value into a signal indicative of the NOx level therein.

Controller 60 may include one or more microprocessors, a memory, a data storage device, a communication hub, and/or other components known in the art and may be associated only with first and second power sources 20 and 22. However, it is contemplated that controller 60 may be integrated within a general control system capable of controlling additional functions of power system 10, e.g. and/or additional subsystems operatively associated with power system 10, e.g., selective control of transmission unit 18.

Controller 60 may receive signals from NOx sensors 54, 58 and ammonia sensor 56 and analyze the data to determine the amount of NOx and ammonia in the exhaust gas. Upon receiving input signals from sensors NOx sensors 54, 58 and ammonia sensor 56, controller 60 may perform a plurality of operations, e.g., algorithms, equations, subroutines, reference look-up maps or tables to determine whether the NOx and ammonia levels are optimal and establish an output to influence the air/fuel ratio of the air/fuel mixture combusted by engines 24 and 26. Alternatively, it is contemplated that controller 60 may receive signals from various sensors (not shown) located throughout power system 10 instead of NOx sensors 54, 58 and ammonia sensor 56. Such sensors may sense parameters that may be used to calculate the amount of NOx and ammonia in exhaust system 30.

Transmission unit 18 may include numerous components that interact to transmit power from power system 16 to traction device 12. In particular, transmission unit 18 may be a multi-speed bidirectional mechanical transmission having a neutral gear ratio, a plurality of forward gear ratios, a reverse gear ratio, and one or more clutches (not shown). The clutches may be selectively actuated to engage predetermined combinations of gears (not shown) to produce a desired output gear ratio. It is contemplated that transmission unit 18 may be an automatic-type transmission, with shifting based on a power source speed, a maximum selected gear ratio, and a shift map, or a manual-type transmission, with shifting between each gear directly initiated by an operator. The output of transmission unit 18 may be connected to and configured to rotatably drive traction device 12 via output shaft 62, thereby propelling machine 10.

It is contemplated that transmission unit 18 may alternately embody a hydraulic transmission having one or more pumps and hydraulic motors, a hydro-mechanical transmission having both hydraulic and mechanical components, an electric transmission having a generator and one or more electric motors, an electro-mechanical transmission having both electrical and mechanical components, or any other suitable transmission. It is also contemplated that transmission unit 18 may alternately embody a continuously variable transmission such as, for example, an electric transmission having a generator and an electric motor, a hydraulic transmission having a pump and a fluid motor, or any other continuously variable transmission known in the art.

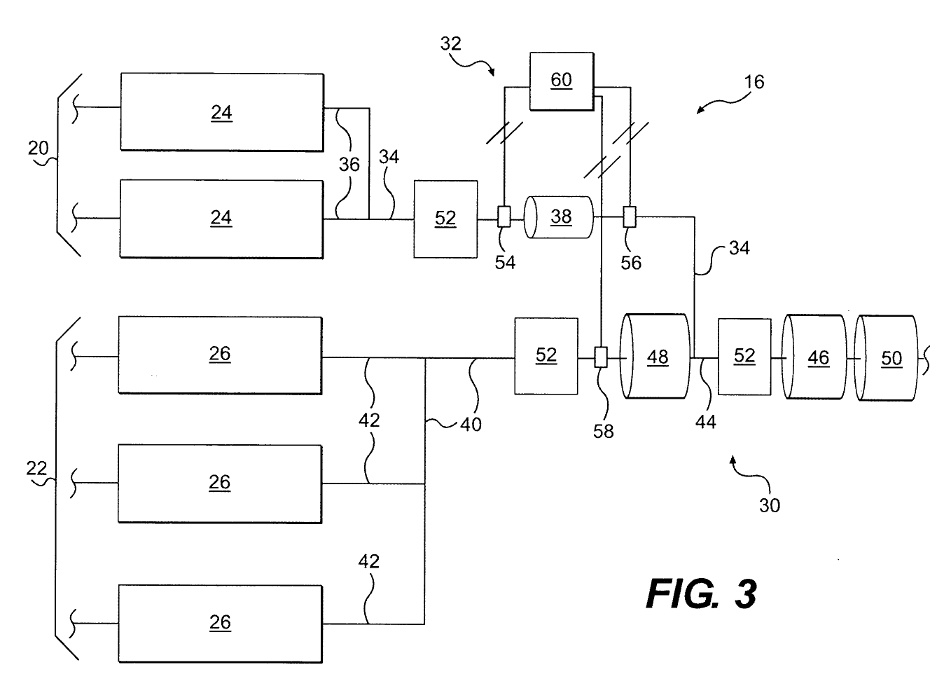

FIG. 3 illustrates another exemplary embodiment of power system 16 used in applications such as, for example, powering marine vessels, powering land-based vehicles, and various industrial applications. In the exemplary embodiment illustrated in FIG. 3, rich engines 24 of first power source 20 may operate independently of each other to produce separate mechanical or electrical outputs. In addition, lean engines 26 of second power source 22 may operate independently of each other to produce separate mechanical or electrical outputs. Furthermore, first power source 20 and second power source 22 may operate independently of each other to produce separate mechanical or electrical outputs. It should be understood that the configuration of exhaust system 30 illustrated in FIG. 3 may be similar to the embodiment disclosed in FIG. 2.

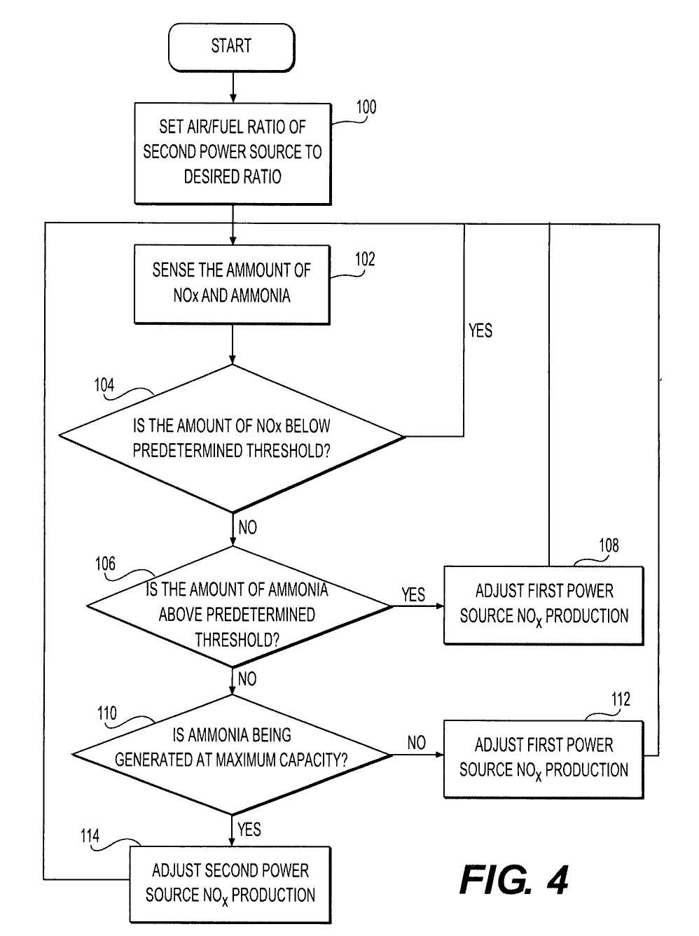

FIG. 4, which is discussed in the following section, illustrates the operation of power sources 20 and 22 utilizing embodiments of the disclosed system. Specifically, FIG. 4 illustrates an exemplary method for regulating the air/fuel ratio of the air/fuel mixture combusted by engines 24 and 26 for optimal exhaust emission levels.

### INDUSTRIAL APPLICABILITY

The disclosed multi-engine system may reliably and efficiently remove or reduce NOx emissions from exhaust that is released into the atmosphere. In particular, the disclosed multi-engine system may eliminate the need for peripheral equipment such as burners or storage tanks to supply ammonia necessary for NOx reduction to the exhaust treatment system. By designating one engine or set of engines to facilitate the generation of ammonia, the multi-engine system itself may supply the ammonia required to remove or reduce NOx emissions from the exhaust released into the atmosphere. The operation of first and second power sources 20 and 22 will now be explained.

FIG. 4 illustrates a flow diagram depicting an exemplary method for generating an optimal level of NOx and ammonia in the exhaust to meet emission standards. The method may begin when the air/fuel mixture to be combusted by second power source 22 is set to a desired air/fuel ratio (step 100). The desired ratio may be any ratio capable of producing a desired result related to the operation of first and second power sources 20 and 22. Such desired results may include, for example, fuel efficiency or maximum mechanical or electrical power generation. In addition, it should be understood that the air/fuel ratio of the air/fuel mixture entering second power source 22 may be leaner than stoichiometric. Furthermore, the air/fuel ratio may be regulated by any method known in the art such as, for example, adjusting the setting of a throttling valve (not shown).

Once the air/fuel mixture is set to the desired ratio, controller 60 may receive signals indicative of the amount of NOx and ammonia in exhaust system 30 from NOx sensors 54 and 58 and ammonia sensor 56 (step 102). Controller 60 may compare the sensed amount of NOx to tables, graphs, and/or equations stored in its memory to determine whether the sensed amount of NOx is below a predetermined threshold (step 104). Such a threshold may be related to government regulated emissions limits or any other threshold related to the amount of emissions released into the atmosphere. If controller 60 determines that the sensed amount of NOx is below the predetermined threshold (step 104: YES), step 102 may be repeated (i.e. controller 60 may receive new signals from NOx sensors 54, 58 and ammonia sensor 56 indicative of new NOx and ammonia levels). However, if controller 60 determines that the amount of NOx is above the predetermined threshold (step 104: No), controller 60 may determine whether the amount of ammonia in exhaust system 30 is above a predetermined threshold for exhaust treatment (step 106).

The predetermined threshold may be dependant upon the amount of NOx in exhaust system 30. For example, the desired amount ammonia may increase when the amount of NOx increases and decrease when the amount of NOx decreases. In addition, controller 60 may determine the desired amount of ammonia for a particular amount of NOx by referencing look-up maps and/or tables and/or performing algorithms, equations, or subroutines. If controller 60 determines that the amount of ammonia in exhaust system 30 is below the predetermined threshold (step 106: No), controller 60 may adjust the amount of NOx being produced by first power source 20 to reduce the generation of ammonia (step 108). For example, controller 60 may decrease the amount of NOx by decreasing the power output of first power source 20. The power output may be decreased by reducing the amount of air and fuel entering first power source 20. It should be understood that, regardless of the power output, the air/fuel mixture being combusted by first power source 20 may be maintained at a constant air/fuel ratio that is richer than stoichiometric. It is contemplated that other techniques may be employed to reduce the amount of NOx produced by first power source 20. Such techniques may include, for example, adjusting the timing of combustion. Once the amount of NOx being produced has been adjusted, step 102 may be repeated (i.e. controller 60 may receive new signals from NOx sensors 54, 58 and ammonia sensor 56 indicative of new NOx and ammonia levels).

If controller 60 determines the amount of ammonia in exhaust system 30 is below predetermined threshold (step 106: Yes), then controller 60 may determine whether ammonia catalyst 38 is operating at its maximum capacity (step 110). Controller 60 may make this determination by referencing look-up maps and/or tables and/or performing algorithms, equations, or subroutines. If controller 60 determines that ammonia catalyst 38 is operating below its maximum capacity (step 110: No), controller 60 may adjust the amount of NOx being produced by first power source 20 to increase the generation of ammonia (step 112). For example, controller 60 may increase the amount of NOx by boosting the power output of first power source 20. The power output may be boosted by increasing the amount of air and fuel entering first power source 20. It should be understood that, regardless of the power output, the air/fuel mixture being combusted by first power source 20 may be maintained at a constant air/fuel ratio that is richer than stoichiometric. It is contemplated that other techniques may be employed to increase the amount of NOx produced by first power source 20. Such techniques may include, for example, adjusting the timing of combustion. Once the amount of NOx being produced has been adjusted, step 102 may be repeated (i.e. controller 60 may receive new signals from NOx sensors 54, 58 and ammonia sensor 56 indicative of new NOx and ammonia levels).

If controller 60 determines that ammonia catalyst 38 is operating at its maximum capacity (step 110: Yes), controller 60 may reduce the amount of NOx being produced by second power source 22 (step 114). For example, controller 60 may decrease the amount of NOx by decreasing the power output of second power source 22. The power output may be decreased by reducing the amount of air and fuel entering second power source 22. It should be understood that, regardless of the power output, the air/fuel mixture being combusted by second power source 22 may be maintained at a constant air/fuel ratio that is leaner than stoichiometric. It is contemplated that other techniques may be employed to reduce the amount of NOx produced by second power source 22. Such techniques may include, for example, adjusting the timing of combustion. Once the amount of NOx being produced has been adjusted, step 102 may be repeated (i.e. controller 60 may receive new signals from NOx sensors 54, 58 and ammonia sensor 56 indicative of new NOx and ammonia levels).

The disclosed system may generate as much ammonia as required to reduce or remove NOx emissions from exhaust released into the atmosphere. Because any oxygen present in the ammonia-producing catalyst may hinder production of ammonia and limit the amount produced, it may be desired to minimize amount of oxygen in the ammonia-producing catalyst. By isolating the rich (low-oxygen) exhaust of the engine or set of engines designated for facilitating the generation of ammonia from the lean (high-oxygen) exhaust generated by the other engine or set of engines the amount of oxygen present in the ammonia-producing catalyst may be minimized. In addition, the engine or set of engines designated for facilitating ammonia production may be configured to combust a rich air/fuel mixture at temperatures that are conducive for NOx production, which is necessary for ammonia generation.

In addition, the disclosed system may consume a substantially similar amount of fuel to produce a particular mechanical or electrical output as a conventional multi-engine system without on-board ammonia production. This is because exhaust used to generate the ammonia may be produced by engines that contribute to the production of the mechanical and electrical output of the system. Therefore, an additional separate supply of fuel is not necessary for ammonia production, thereby reducing costs and increasing efficiency of the system.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. A power system, comprising:
a first power source including at least one engine configured to combust a first air/fuel mixture and produce a first exhaust stream;
a first exhaust passageway fluidly connected to the first power source and configured to receive the first exhaust stream;
a second power source including at least one engine configured to combust a second air/fuel mixture and produce a second exhaust stream;
a second exhaust passageway fluidly connected to the second power source and configured to receive the second exhaust stream; and
a first catalyst disposed within the first exhaust passageway to convert at least a portion of the first exhaust stream to ammonia.

2. The power system of claim 1, wherein the first and second exhaust passageways are fluidly connected downstream from the first catalyst to form a merged exhaust passageway configured to receive a combined exhaust stream.

3. The power system of claim 2, further including a second catalyst disposed within the merged exhaust passageway.

4. The power system of claim 3, wherein the second catalyst is configured to facilitate a reaction between ammonia and NOx in the combined exhaust stream to at least partially remove NOx from the combined exhaust stream.

5. The power system of claim 4, further including at least one sensor configured to sense a parameter indicative of an amount of NOx in the first and/or second exhaust passageways and at least one sensor configured to sense a parameter indicative of an amount of ammonia in the first exhaust passageway.

6. The power system of claim 5, further including a controller configured to adjust the amount of NOx produced by the first and/or second power sources in response to the sensed amount of NOx and/or ammonia.

7. The power system of claim 1, wherein the first air/fuel mixture is richer than stoichiometric condition.

8. The power system of claim 7, wherein the second air/fuel mixture is leaner than stoichiometric condition.

9. A method for operating a power system, comprising:
simultaneously combusting a first and a second air/fuel mixture to produce multiple mechanical outputs;
producing a first and a second exhaust stream from the combustion of the first and second air/fuel mixtures; and
converting at least a portion of the first exhaust stream to ammonia.

10. The power system of claim 1, wherein the first air/fuel mixture is richer than stoichiometric condition, and the second air/fuel mixture is leaner than stoichiometric condition.

11. The method of claim 10, further including combining the first and second exhaust streams after at least a portion of the first exhaust stream is converted to ammonia and catalyzing the combined exhaust stream.

12. The method of claim 11, wherein catalyzing the combined exhaust stream includes facilitating a reaction between ammonia and NOx in the combined exhaust stream to remove NOx from the combined exhaust stream.

13. The method of claim 9, further including sensing a parameter indicative of an amount of NOx and/or ammonia and adjusting the amount of NOx produced by combusting the first and/or second air/fuel mixtures in response to the sensed amount of NOx and/or ammonia.

14. The method of claim 13, wherein adjusting the amount of NOx produced by combusting the first and/or second air/fuel mixtures further includes adjusting the NOx produced by combusting the first air/fuel mixture when the amount of ammonia is below a predetermined threshold and adjusting the amount of NOx produced by combusting the second air/fuel mixture when the amount of ammonia is above a predetermined threshold.

15. A machine, comprising:
at least one traction device;
a first power source configured to power the machine, the first power source including at least one engine configured to combust a first air/fuel mixture;
a second power source configured to power the machine, the second power source including at least one engine configured to combust a second air/fuel mixture;
a transmission configured to transmit at least a portion of the power produced by at least one of the first and second power sources to the at least one traction device;
a first exhaust passageway fluidly connected to the first power source and configured to receive the a first exhaust stream;
a second exhaust passageway fluidly connected to the second power source and configured to receive a second exhaust stream; and
a first catalyst disposed within the first exhaust passageway to convert at least a portion of the first exhaust stream to ammonia.

16. The machine of claim 15, wherein the first air/fuel mixture is richer than stoichiometric condition, and the second air/fuel mixture is leaner than stoichiometric condition.

17. The machine of claim 15, wherein the first and second exhaust passageways are fluidly connected downstream from the first catalyst to form a merged exhaust passageway.

18. The machine of claim 17, further including a second catalyst disposed within the merged exhaust passageway and configured to facilitate a reaction between ammonia and NOx in the first and second exhaust streams to at least partially remove NOx from the first and second exhaust streams.

19. The machine of claim 15, further including at least one sensor configured to sense a parameter indicative of an amount of NOx in the first and/or second exhaust passageways and at least one sensor configured to sense a parameter indicative of an amount of ammonia in the first exhaust passageway.

20. The machine of claim 19, further including a controller configured to adjust the amount of NOx produced by the first and/or second power sources in response to the sensed amount of NOx and/or ammonia.
